(19) United States
(12) Patent Application Publication
(10) Pub. No.: US 2010/0177161 A1
(43) Pub. Date: Jul. 15, 2010

(54) MULTIPLEXED STEREOSCOPIC VIDEO TRANSMISSION

(75) Inventors: William Allen Curtis, Austin, TX (US); Thomas Alexander Shows, Leander, TX (US)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/354,023

(22) Filed: Jan. 15, 2009

(51) Int. Cl. H04N 13/00; H04N 13/04

(52) U.S. Cl. 348/43; 348/51; 348/E13.001

(57) ABSTRACT

An information handling system (IHS) includes a processor, a memory coupled to the processor, and a graphics processor coupled to the processor, wherein the graphics processor processes a progressive stereoscopic video signal having at least 1080 lines of resolution and a refresh rate of substantially 48 herz.

### BACKGROUND

The present disclosure relates generally to information handling systems, and more particularly to multiplexed stereoscopic video transmission using an information handling system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

FIG. 1 illustrates embodiments of prior art video transmissions. When these systems are used for transmission of stereoscopic video between a source device and display device, the video image and/or motion video quality using existing video transmission standards is sacrificed. There are a variety of video timings defined as industry standards, most notably CEA-861. These profiles specific the timings, discovery structures and data transfer structures for building uncompressed, baseband, digital interfaces for digital televisions and other CE sync equipment. Format discovery often uses Video Electronics Standards Association extended display identification data (VESA E-EDID) information as well.

These existing standards are generally focused on non-stereoscopic video content and are inadequate at addressing the additional bandwidth, description and discovery types needed to encompass stereoscopic video content transmission. For example, the existing standards do not provide descriptions or adequate bandwidth for stereoscopic video formats. This results in a variety of sacrifices in quality in order to transmit stereoscopic video using the existing definitions.

The most common sacrifice is to transmit the stereoscopic video pair in single frame of video. A variety of methods exist to do this, such as above/below, left/right, row interleaved, checkerboard, and others. These methods reduce the number of pixels by half, and vary only in the method of pixel selection. Above/below uses two intraframe fields of half resolution by eliminating every other row of pixels. Left/right functions similarly, eliminating every other column of pixels. Row interleaved eliminates every other row, but alternates even and odd in the X (width) direction. Checkerboard eliminates every other pixel in both the X (width) and Y (height) direction, alternating between left eye and right eye. By eliminating this pixel data during transmission, it is necessary to reconstruct the missing data in the display device to fill in the gaps in transmission.

Another method is to transmit stereoscopic pairs in a frame sequential (temporal multiplex) manner, so that a full resolution left eye image is followed by a full resolution right eye image, and so forth. This method is common today in stereoscopic projectors which support 120 Hz refresh rates. However, this method introduces loss in film/video quality due to the 2:3 pull down which occurs in the source prior to transmission of the 60 Hz stereoscopic signal, as is commonly understood by those having ordinary skill in the art. In other words, film is captured in a native format of 24 frames per second, and in order to match 60 Hz televisions systems, 4 frames of video are stretched into 5. Thus, the film speed of 23.976 fps is converted into 29.97 fps, and the intermediate frame created in this process results in an unwanted artifact called judder.

Accordingly, it would be desirable to provide an improved system for multiplexed stereoscopic video transmission absent the disadvantages discussed above.

### SUMMARY

According to one embodiment, an information handling system (IHS) includes a processor, a memory coupled to the processor, and a graphics processor coupled to the processor, wherein the graphics processor processes a progressive stereoscopic video signal having at least 1080 lines of resolution and a refresh rate of substantially 48 herz.

### BRIEF DESCRIPTION OF THE DRAWINGS

FIG. 1 illustrates embodiments of prior art video transmissions.

FIG. 2 illustrates an embodiment of an information handling system (IHS) operable to perform multiplexed stereoscopic video transmissions.

FIG. 3 illustrates an embodiment of a multiplexed stereoscopic video transmission.

FIG. 4 illustrates systems for transmitting multiplexed stereoscopic video.

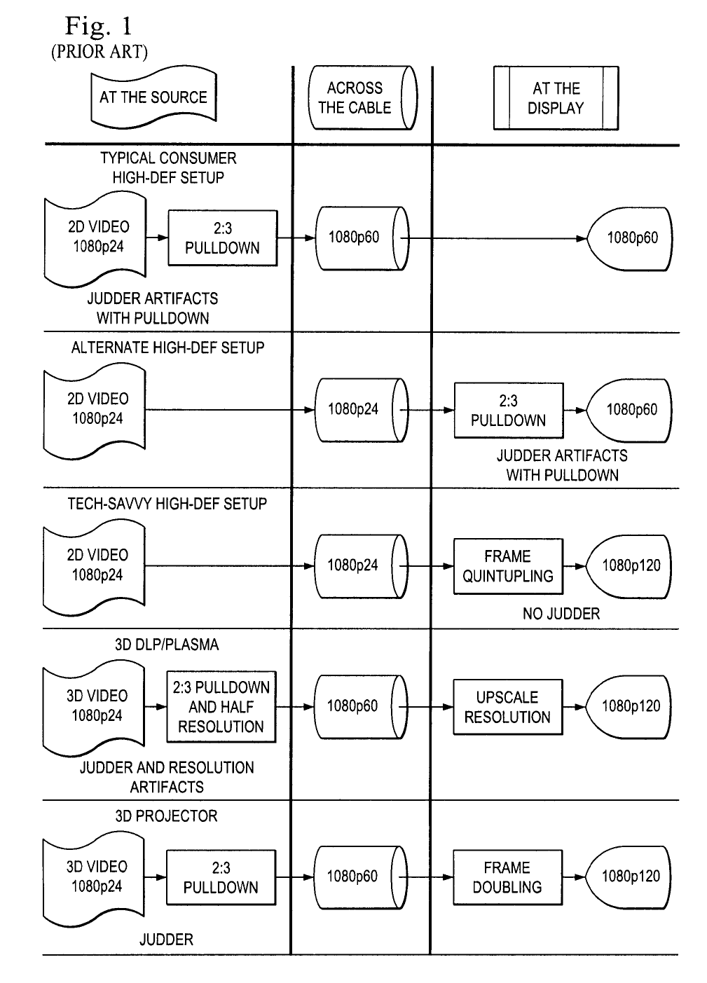

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

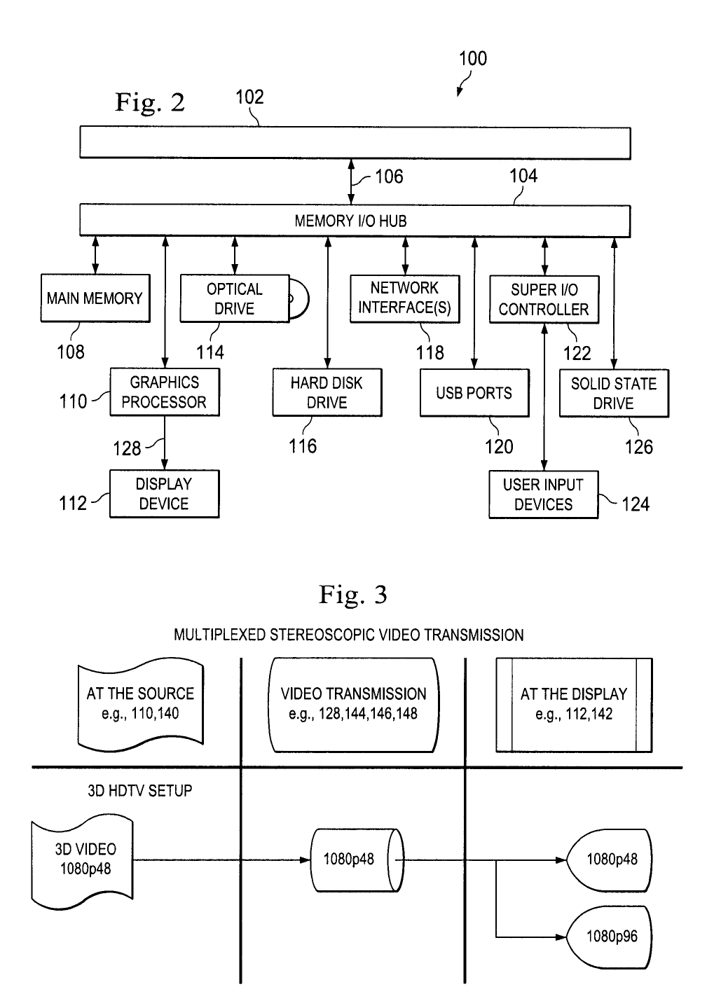

FIG. 2 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals, via a video cable 128, to a display device 112, wherein the display device 112 may include an image display surface for displaying an image.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126 in place of, or in addition to main memory 108, the optical drive 114, and/or a hard disk drive 116. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 2, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

Cinematic motion pictures are generally recorded on film at a rate of 24 frames per second. On the other hand, television video is generally transmitted at 25 or 30 frames per second. Therefore, when trying to transmit motion pictures to televisions a conversion process is traditionally necessary to reduce unwanted flickering or judder. This process of converting motion picture film frames to video form for transmitting to televisions is known as telecine. By transmitting and displaying video content in a multiple of the original cinematic motion picture film frame rate, judder can be virtually eliminated. In other words, by having the video signal converted from the film frames to video using a multiple of the film frame rate, the flickering when the film frame is changed in mid field of the video frame is eliminated.

FIG. 3 illustrates an embodiment of a multiplexed stereoscopic video transmission. As shown, the video signal may be a 3-dimentional, HDTV signal, however, other video signals are contemplated. This signal may be generated, converted, transmitted, received or otherwise processed using an IHS, such as the IHS 100. HDTV is generally considered high definition television having very clear image reproduction. In video images, 3-dimentional video may be considered stereoscopic video where one image is used for the left eye and a corresponding image is used for the right eye. As such, the mind combines the images and appears to be viewing a 3-dimentional image. In an embodiment, the video signal is transmitted as a multiple of the original cinematic motion picture film rate, such as, 48, 96, etc. frames per second. Also in an embodiment, the video signal is transmitted as having 1080 horizontal lines of resolution per frame, although other numbers of lines of resolution is acceptable. For example, the signal may be transmitted as 1080p48 video, where the “p” represents a progressive video scan including every line of video is refreshed each scan. Additionally, the signal may be transmitted as 1080i48 video, where the “I” represents an integrated video scan including every other line of video is refreshed each scan. As should be understood in the art, a progressive video scan including every line of video requires more transmission bandwidth, but provides a clearer video picture than an integrated video scan, especially during motion on the video, such as while gaming or viewing sporting events. The video timing standard for the transmission of 3-dimentional video content shown in FIG. 3 preserves video quality within the constraints of bandwidth and other factors of current industry standards. In an embodiment, the video timings are set to 48 p with the specific purpose of transmitting frame sequential (temporally multiplexed) stereoscopic video in the format of Left0, Right0, Left1, Right1, and so forth. Therefore, high definition video without the flicker and/or judder may be transmitted using the high-definition multimedia interface (HDMI) video communication system.

Thus, video timing which would normally be transmitted in 24 frames-per-second progressive scan (e.g., 720p24, 1080p24), the stereoscopic equivalent with each eye view representing 1 frame can be represented in 48 frames-per-second. Current uses for 48 frames per second video are limited to monoscopic video for eliminating frame rate conversion judder. In otherwords, an embodiment of the present disclosure provides a system and method for video transmission using 48 frames per second including two-24 frames per second video. In an embodiment, one 24 frames per second portion of the video may be used for video for the left eye and the other 24 frames per second portion of the video may be used for video for the right eye.

By using full resolution frames of video at 48 frames-per-second, no spatial artifacts are introduced due to decompression, or the creation of video data where information did not otherwise exist when transmitted. Furthermore, by specifying 48p (as opposed to 72p, 96p, 120p), the highest current dimensional timing (1920×1080) may be transmitted at 48p and remain within the bandwidth constraints of the existing consumer electronics physical layer and protocol layer definitions, such as HDMI.

As should be readily understood by a person having ordinary skill in the art, the disclosed video transmission improves transmission of stereoscopic video because prior video transmissions either compress spatially, temporally, frequency-wise, or otherwise require frame rate conversion at the source prior to transmission. The present disclosure improves upon 60p stereoscopic transmission because the 60p stereoscopic transmission convert 60p video to be displayed at 120 Hz refresh rate, and synchronized with stereoscopic shutter glasses. As such, the present disclosure eliminates the 2:3 pull down requirement imposed on the host. This pull down requires additional complexity burden on the host, reduces the amount of cinematic video quality possible, and varies by host implementation. By eliminating this pull down step, frame rate conversion can be determined by the display device, enabling the best quality match according to the method of display rather than the transmission source capabilities.

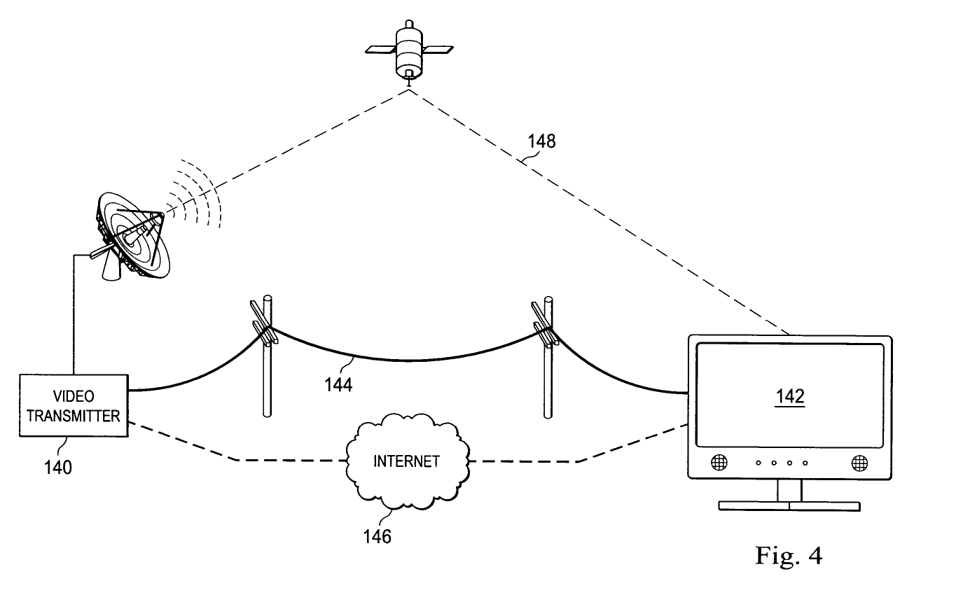

FIG. 4 illustrates systems for transmitting multiplexed stereoscopic video. The stereoscopic video transmission disclosed may be generated, converted or otherwise processed using a video transmitter 140. The video transmitter 140 may transmit the video signal to a video display device 142 using cable television or telephone infrastructure/communication 144, the Internet infrastructure/communication 146 and/or satellite or other wireless infrastructure/communication 148.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. An information handling system (IHS) comprising:
a processor;
memory coupled to the processor; and
a graphics processor coupled to the processor, wherein the graphics processor processes a progressive stereoscopic video signal having at least 1080 lines of resolution and a refresh rate of substantially 48 herz.

2. The IHS of claim 1, wherein the progressive stereoscopic video signal includes a format of left0, right0, left1 and right1.

3. The IHS of claim 1, wherein the progressive stereoscopic video signal is substantially 48 frames per second.

4. The IHS of claim 1, wherein the graphics processor is operable to convert cinematic film images to video without using 2:3 pulldown.

5. The IHS of claim 1, wherein the stereoscopic video signal is generated during gaming using the IHS.

6. The IHS of claim 1, wherein the progressive stereoscopic video signal is transmitted from a source to a display without a need for 2:3 pulldown or frame quintupling.

7. A video display device comprising:
an image projection surface; and
a graphics processor for receiving a progressive stereoscopic video signal and processing the progressive stereoscopic video signal for displaying on the image projection surface, wherein the progressive stereoscopic video signal includes at least 1080 lines of resolution and a refresh rate of substantially 48 herz.

8. The video display device of claim 7, wherein the progressive stereoscopic video signal includes a format of left0, right0, left1 and right1.

9. The video display device of claim 7, wherein the progressive stereoscopic video signal is substantially 48 frames per second.

10. The video display device of claim 7, wherein the graphics processor is operable to process cinematic film images for video without using 2:3 pulldown.

11. The video display device of claim 7, wherein the stereoscopic video signal is displayed during gaming.

12. The video display device of claim 7, wherein the progressive stereoscopic video signal is transmitted from a source to the display without a need for 2:3 pulldown or frame quintupling.

13. A method for multiplexed stereoscopic video transmission, the method comprising:
receiving cinematic motion picture images at a frame rate;
converting the cinematic motion pictures images to a digital stereoscopic video signal, wherein the digital stereoscopic video signal is configured for a display refresh rate that is a multiple of the frame rate, thereby eliminating a need for 2:3 pulldown or frame quintupling; and
transmitting the digital stereoscopic video signal for displaying as a three dimensional image.

14. The method of claim 13, wherein the stereoscopic video signal includes a format of left0, right0, left1 and right1.

15. The method of claim 13, wherein the frame rate is substantially 48 frames per second.

16. The method of claim 13, wherein a graphics processor is operable to convert cinematic film images to video without using 2:3 pulldown.

17. The method of claim 13, wherein the stereoscopic video signal is generated during gaming.

18. The method of claim 13, wherein the progressive stereoscopic video signal is transmitted from a source to a display without a need for 2:3 pulldown or frame quintupling.
